(19) United States
(12) Patent Application Publication
(10) Pub. No.: US 2016/0144373 A1
(43) Pub. Date: May 26, 2016

(54) AGITATOR MEANS FOR VERTICAL GRINDING MILLS

(71) Applicant: Metso Minerals Industries, Inc., Waukesha, WI (US)

(72) Inventors: Allen Everett Haas, Seven Valleys, PA (US); Brady Wayne McNaughton, Camp Hill, PA (US)

(73) Assignee: Metso Minerals Industries, Inc., Waukesha, WI (US)

(21) Appl. No.: 14/548,436

(22) Filed: Nov. 20, 2014

(51) Int. Cl. B02C 17/16; B01F 7/00

(52) U.S. Cl. CPC B02C 17/163; B01F 7/00416

(57) ABSTRACT

The present invention concerns agitator means for a vertical grinding mill, which includes a screw flight system having a shaft and at least one screw flight. According to the invention the screw flight system is provided in at least two segments, wherein each segment comprises at least one screw flight section integral to a shaft section, and wherein the at least two segments are arranged for assembling to one another to form the screw flight system. The present invention further concerns a vertical grinding mill comprising agitation means according to above, and a construction assembly for agitation means according to above.

### FIELD OF THE INVENTION

The present invention relates to an agitator means for a vertical grinding mill comprising a screw flight system having a shaft and at least one screw flight. The present invention further relates to a vertical grinding mill comprising above agitation means, and a construction assembly for said agitation means.

### BACKGROUND

Vertical grinding mills are known, e.g., from U.S. Pat. No. 4,660,776 and from the brochure “VERTIMILL™-Fine and ultrafine wet grinding”. A vertical grinding mill has a chamber in which an agitator is arranged. Grinding media, which may be made out of e.g. steel or ceramics and which may have different shapes, such as balls or natural pebbles, is provided in the chamber. Water, the material to be ground, and optionally additives are fed into the chamber. By rotating the agitator, the charge is agitated, such that the grinding media grinds the material to be ground by abrasion and attrition. The two references mentioned above disclose vertically arranged stirred mills. However, the same general principle is used in stirred mills with e.g. tilted arrangement.

The chamber retains the grinding media and, in case of a vertically arranged n the chamber also supports the drive components including the agitator.

The agitator which rotates and imparts motion to the grinding media consists, in the VERTIMILL™, of an inner welded screw flight system that supports a number of outer wear liners, which are bolted onto the welded screw flight system. The welded screw flight system according to this prior art is composed of a shaft, and a number of screw flights, which are welded onto the shaft to form a continuous helical blade longitudinal of the shaft.

In U.S. Pat. No. 4,242,002 another agitator means has been disclosed for a vertical grinding mill. This agitator means also has an inner welded blade along a centre shaft in form of a screw. Said inner welded blade is disclosed to have a relative small diameter, measured from the centre of the shaft, while a number of outer blade units having relative large diameter, measured from the centre of the shaft, and a screw pitch equal to the same of the inner blade are positioned side by side along the periphery of the inner blade and are fixed to the inner blade by means of bolts and nuts so that a continuous screw blade assembly is formed by the inner blade and a number of outer blade units.

While these known vertical grinding mills perform satisfactory, mining operations are more and more located in remote locations with limited access and restricted shipping possibilities. Some sites are not even accessible by road but only by rail and this further limits the size of the shipping components to specific dimensions to fit through train tunnels. At the same time, the mining operations call for larger vertical grinding mills to process larger tonnages for low grade ore bodies with finely disseminated valuable minerals to be recovered more economically. Further, from a manufacturing point of view, the larger the mills and the components become, the possible sites where the components may be manufactured decreases, which further increase the shipping costs and lead times. Further, the larger the stirred mill, the greater the costs are to meet various shipping restrictions for the components.

### SUMMARY

An object of the invention is to provide agitator means, which requires less transportation space.

Another object of the invention is to provide agitator means, which is easier to manufacture.

According to a first aspect of the invention, these and other objects are achieved, in full or at least in part, by agitator means for a vertical grinding mill, which agitator means comprises a screw flight system having a shaft and at least one screw flight, wherein said screw flight system is provided in at least two segments, wherein each segment comprises at least one screw flight section integral to a shaft section, and wherein said at least two segments are arranged for assembling to one another to form said screw flight system.

The assembled segments will function exactly as the welded screw flight system disclosed above and will support wear lining elements to be arranged thereon. However, having it fabricated in segments like this increases the number of possible manufactures, and reduces the costs for shipping.

According to one embodiment, said each shaft section has at. least one assembling flange for said assembling to another adjacent shaft section to form said screw flight system.

Thus, in this embodiment each segment is arranged with a flange to face a corresponding flange on an adjacent shaft section for assembling by e.g. bolting, like with bolts and nuts. Thus, in one embodiment said assembling flange is a bolting arrangement flange.

According to another embodiment, said each segment comprising at least one screw flight section integral to a shaft section is casted, molded and/or forged as one integral segment.

Said each segment may be manufactured in the shape having at least one screw flight section integral to a shaft section in casted steel or casted ductile iron.

In one embodiment each segment comprises two flight sections integral to a shaft section.

In one embodiment each at least one screw flight section in each segment is formed in such a manner that a lower end of said at least one screw flight section is positioned circumferentially shifted up to 180° from an upper end of said at least one screw flight section. In another embodiment each at least one screw flight section in each segment is formed in such a manner that a lower end of said at least one screw flight section is positioned circumferentially shifted up to 90° from an upper end of said at least one screw flight section.

According to another embodiment, said at least one screw flight section in one segment forms a helical continuous screw flight with a corresponding at least one screw flight section in an adjacent segment in said screw flight system. Further, as one alternative to this embodiment, said at least one screw flight section has at least one bolting arrangement edge for assembling to said corresponding at least one screw flight section in an adjacent segment in said screw flight system to form said helical continuous screw flight.

In one embodiment of the present invention, the screw flight system further comprises wear lining elements arranged on and supported by said screw flight sections. Said wear lining elements may be bolted and/or welded onto said screw flight sections, and may in one embodiment be arranged such that wear lining elements bridge any screw flight section assembly. Thus, with such an arrangement a boundary between two adjacent screw flight sections which belong to two adjacent segments is covered by a wear lining element arranged thereon and supported by both said screw flight sections.

In one embodiment of the present invention, said shaft and said shaft sections may have a cylindrical shape. Different cross sectional shapes are possible for said shaft and said shaft section, such as a circular cross section, a hexagonal cross section, an octagonal cross section, etc.

According to a second aspect of the invention, these and other objects are also achieved, in full or at least in part, by a vertical grinding mill comprising an agitator means as disclosed above.

According to a third aspect of the invention, these and other objects are also achieved, in full or at least in part, by a construction assembly for agitation means as disclosed above, which comprises at least two segments, each segment comprising at least one screw flight section integral to a shaft section, wherein said at least two segments are arranged to be assembled to one another to form a screw flight system.

Other objectives, features and advantages of the present invention will appear from the following detailed disclosure, from the attached claims, as well as from the drawings. It is noted that the invention relates to all possible combinations of features.

Generally, all terms used in the claims are to he interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “comprising” and variations of that term are not intended to exclude other additives, components, integers or steps.

Various other features, objects and advantages of the invention will be made apparent from the following description taken together with the drawings.

### BRIEF DESCRIPTION OF THE DRAWINGS

The invention will be described in more detail with reference to the appended schematic drawings, which show an example of a presently preferred embodiment of the invention.

FIG. 1a is a perspective view of a typical vertical grinding mill according to prior art.

FIG. 1b is an inner view of a grinding chamber during grinding according to prior art

FIG. 2a is a perspective view of one agitator means according to prior art with wear lining elements.

FIG. 2b is a perspective view of a screw flight system of FIG. 2a without the wear lining elements, and with the screw flight section in place but before having welded the screw flight sections onto the shaft.

FIG. 3 is a perspective view of a first segment of a screw flight system according to one embodiment of the present invention.

FIG. 4 is a perspective view of a second segment of a screw flight system according to one embodiment of the present invention.

FIG. 5a is a perspective view of the two segments from FIG. 3 and FIG. 4 assembled into a screw flight system according to one embodiment of the present invention.

FIG. 5b is a perspective view of two segments assembled into a screw flight system according to another embodiment of the present invention.

FIG. 6 is a perspective view of the screw flight system from FIG. 5a or FIG. 5b with wear lining elements arranged on and supported by a screw flight system from FIG. 5a or FIG. 5b.

### DEFINITIONS

As used in this patent publication, the term “integral”, such as “one part being integral with another part”, means that the disclosed parts are manufactured into or from one piece of material. Thus, the at least one screw flight section is manufactured in one piece together with the shaft section, such as by casting, molding, and/or forging the shaft section and the at least one screw flight section into one piece of material.

As used in this patent publication, the term “bridges” means when a first part covers any gap or borderline between two other parts, which two parts are assembled together or brought into contact with each other

### DETAILED DESCRIPTION

The present invention will now be described more fully hereinafter with reference to the accompanying drawings, in which currently preferred embodiments of the invention are shown. The present invention may, however, be embodied in many different forms and should not be construed as limited to the embodiments set forth herein; rather, these embodiments are provided for thoroughness and completeness, and to fully convey the scope of the invention to the skilled addressee. Like reference characters refer to like elements throughout.

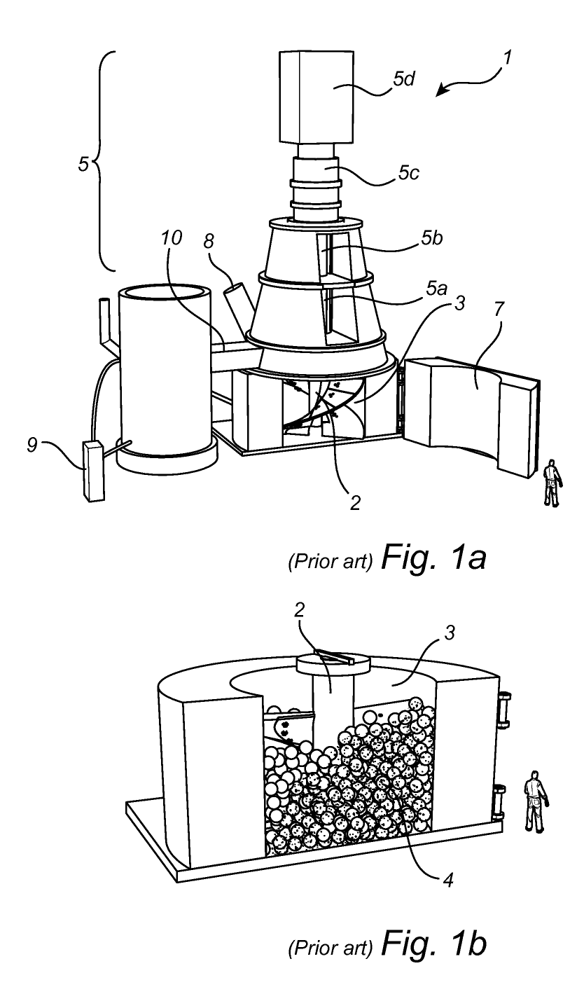

FIG. 1 a shows a vertical grinding mill 1 according to prior art. The stirred mill comprises an agitator 2 arranged in a grinding chamber 3. As shown in FIG. 1b, the chamber 3 is filled with grinding media 4, which may be made out of e.g. steel or ceramics and which may have different shapes, such as balls or natural pebbles. Slurry of water, material to be ground, and optionally additives are fed to an opening 8 at the top of the chamber 3 and the agitator 2 is rotated, thereby agitating and imparting motion to the grinding media 4, which grinds the material to be ground within the chamber 3. An external recycle pump 9 provides an uprising velocity flow within the chamber 3 which causes a classification of particles in the upper portion of the chamber 3. The grinded particles moving towards the upper portion of the chamber 3 is removed via an overflow launder 10. The small particles rise, while the large particles are drawn into the media and ground further.

As shown in FIG. 1a and FIG. 1b the chamber 3 retains the grinding media and also supports the drive components 5, such as driver shall 5a, thrust bearing 5b, gear reducer 5c and motor 5d.

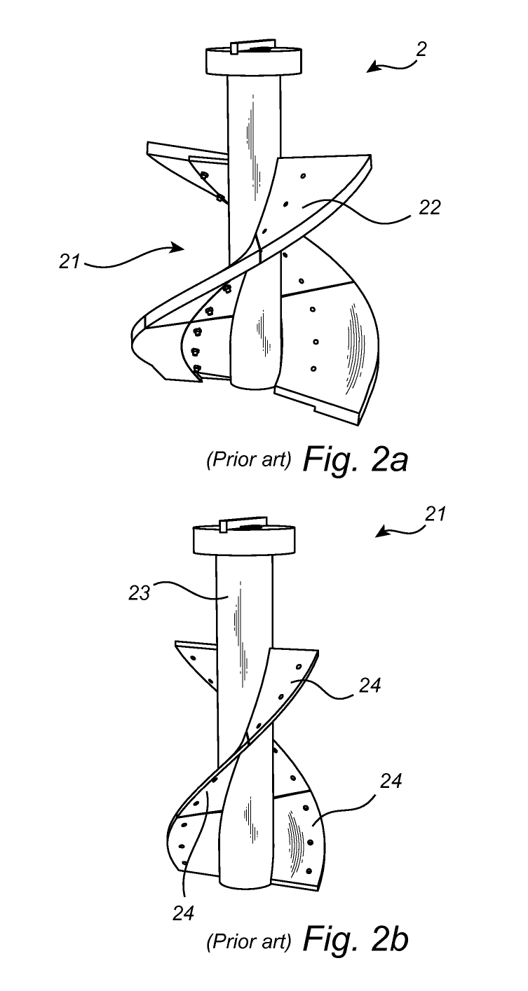

FIG. 2a shows an agitator 2 according to prior an, which comprises an inner welded screw flight system 21 that supports a number of outer wear lining elements 22, which are bolted onto the inner welded screw flight system. As disclosed above, in BACKGROUND section and as shown in FIG. 2b, such an inner welded screw flight system 21 is normally composed of a shaft 23, and a number of screw flight sections 24, which are positioned around and welded onto the shaft 23 and to each other to form a continuous helical blade along of the shaft 23, as shown in FIG. 2b. In FIG. 2b the screw flight sections 24 are shown positioned around the shaft 23, but so far not welded onto the shaft 23.

The mining operation industry are presently facing several challenges, there is a need for more cost effective mill equipments, more and more mining operations are in more and more remote locations with limited access and restrictive shipping requirements. Some mining facilities are not even accessible by road, but only by rail and train tunnels. At the same time there is a need for larger stirred mills to process larger tonnages for low grade ore bodies with finely disseminated valuable minerals to be recovered economically. When manufacturing the agitators according to prior art, the larger the agitators become, the possible manufacturing sites where the components for the agitator may be manufactured decrease, which even farther increases the shipping cost and lead time.

The present inventors have therefore invented an agitator means which requires less transportation space, and which meets the size requirement for any mining, operation premise, and this agitator means may also be manufactured and installed to reduced costs.

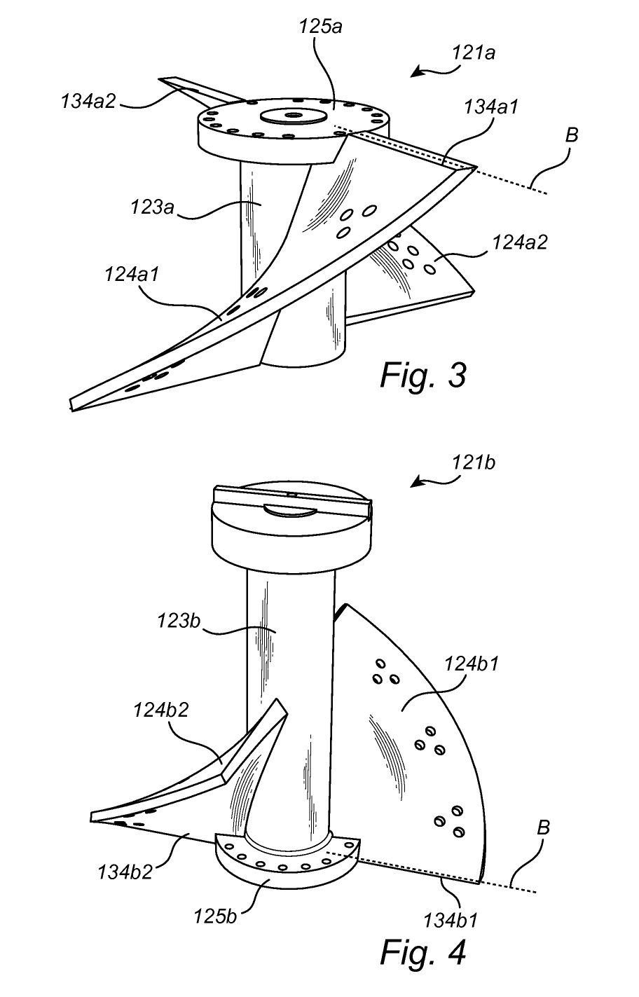

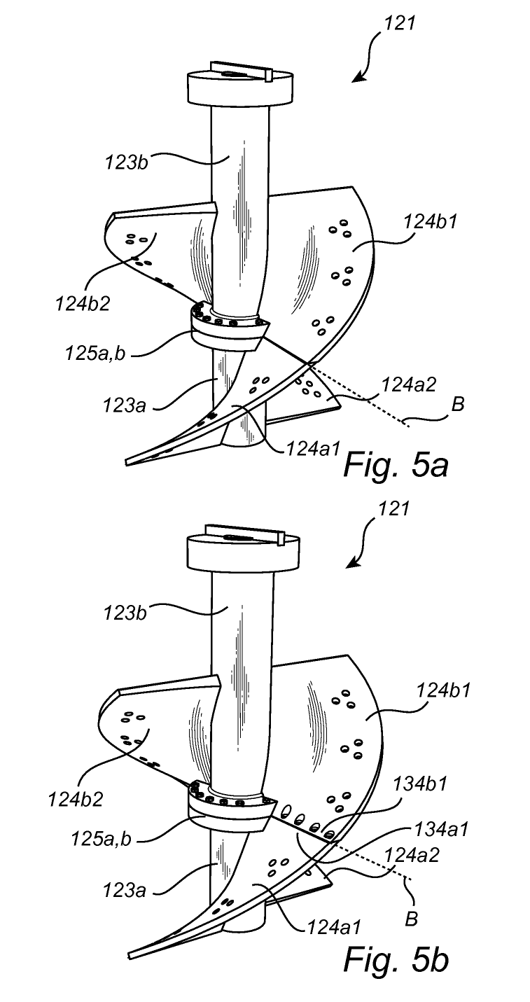

An agitation means according to the invention comprises a screw flight system 121 which is provided in at. least. two segments 121a, 121b as shown in FIG. 3 and FIG. 4. Each segment 121a, 121b comprises at least one screw flight section 124a1, 124a2, 124b1, 124b2 integral to a shaft section 123a, 123b, A complete screw flight system 121 is formed when the at least two segments 121a, 121b are assembled to one another as shown in FIG. 5a and FIG. 5b.

According to the present invention each segment 121a, 121b with the at least one screw flight section 124a1, 124a2, 124b1, 124b2 and the shaft segment 123a, 123b are formed into one piece of material by for example casting, molding and/or forging of steel or ductile iron into the forms as shown in FIG. 3 and FIG. 4. Thus, in one segment 121a, 121b, said at least one screw flight section 124a1, 124a2; 124b1, 124b2 is an integral part of said shaft section 123a; 123b.

As shown here in the Figures and as disclosed above, said at least two segments 121a, 121b are, when on site of the mining operation, assembled to form the screw flight system 121. However, depending on the height of the vertical grinding mill 1 and the width thereof, said screw flight system 121 may be segmented into more than two different segments 121a, 121b.

The at least two segments 121a, 121b of the screw flight system 121 are in one embodiment assembled by placing one over the other, with mutually facing bolting arrangement flanges 125a, 125b and then bolting the two segments together with bolt and nut. However, other alternatives for assembling of the two different segments are possible, such as with bolt and tapped hole, threaded stud and nut, pins, threaded shaft connection, and clamping.

Further the shaft sections 123a, 123b may also be welded together after having been placed on top of each other for the assembling of the screw flight system 121.

In one embodiment, when the assembling of the screw flight system 121 is being made, said at least one screw flight section 124a1, 124a2 on one segment 121a is arranged such that it together with corresponding at least one screw flight section 124b1, 124b2 on an adjacent segment 121b provides a continuous helical screw around the assembled shaft sections 123a, 123b. Thus, a radially extending upper edge 134a1, 134a2 of a screw flight section 124a1, 124a2 of a first screw flight segment 121a is arranged to abut a radially extending lower edge 134b1, 134b2 of a second screw flight section 124b1, 124b2 to form a continuous helical screw flight along the assembled shaft sections 123a, 123b. In the radially extending boundary B where the two screw flight sections 124a1, 124a2, 124b1, 124b2 from the two segments 121a, 121b abut may have at least one bolting arrangement edge 134a1, 134a2, 134b1, 134b2 for assembling the corresponding screw flight sections 124a1, 124a2, 124b1, 124b2 at the radially extending boundary B, as shown in FIG. 5b, where holes for bolting is arranged in the edges 134a1 and 134b1, and also in the (hidden) edges 134a2 and 134b2. However, the edges 134a1, 134a2, 134b1, 134b2 of the two adjacent screw flight sections 124a1, 124a2, 124b1, 124b2 may also, in an alternative embodiment be welded together, as shown in FIG. 5a.

In another embodiment, no fastening. with bolting or welding is used for the boundary B of the two screw flight sections 124a1, 124a2, 124b1, 124b2. Instead the edges 34a1, 134a2, 134b1, 134b2 are provided with fitting arrangement with a close fit, to keep the two screw flight sections 124a1, 124a2, 124b1, 124b2 together, like with a groove and tongue fitting.

In the embodiment shown in FIG. 3 and FIG. 4, each screw flight section 124a1, 124a2, 124b1, 124b2 in each segment 121a, 121b is formed in such a manner that a lower end of each screw flight section 124a1, 124a2, 124b1, 124b2 is positioned circumferentially shifted about 90° from an upper end of said each screw flight section 124a1, 124a2, 124b1. However, circumferentially shifting up to 180° is also possible depending on the size of the agitator means 12 when assembled.

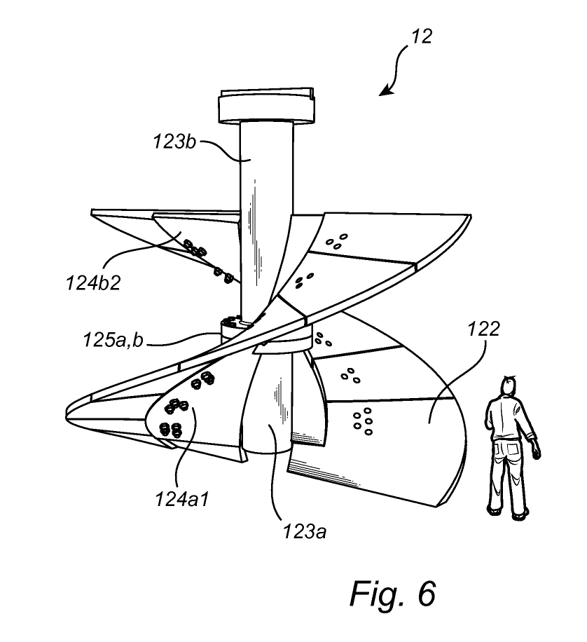

In FIG. 6 an agitator means 12 according to one embodiment of the invention is shown. The agitator means 12 comprises the inner screw flight system 121 assembled by the two screw flight system segments 121a, 121b. Wear lining elements 122 are arranged and supported on the screw flight sections 124a1, 124a2, 124b1, 124b2 of the inner screw flight system 121. In one embodiment the wear lining elements 122 are bolted onto the screw flight sections 124a1, 124a2, 124b1, 124b2 with bolts and nuts, but may in another embodiment be welded thereon.

In even another embodiment, the two edges 134a1, 134a2, 134b1, 134b2 of the radially extending boundary B where two screw flight sections 124a1, 124a2, 124b1, 124b2 from the two segments 121a, 121b abut are only positioned in closed contact, and then the two sections are bridged by the use of overlaying wear lining elements, which are positioned such that said boundary B between the sections 124a1, 124a2, 124b1, 124b2 are covered, bridged and/or overlapped.

In another embodiment of the present invention, the bolting arrangement flanges on the assembled shaft may be protected by sheet metal.

The skilled person realises that a number of modifications of the embodiments described herein are possible without departing from the scope of the invention, which is defined in the appended claims.

The agitator means of the invention is equally applicable to different materials to be ground, such as ore.

In the drawings, a vertically arranged stirred mill is shown. However, the invention may also be applied to stirred mills oriented in other directions.

We claim:

1. Agitator means for a vertical grinding mill, comprising a screw flight system having a shaft and at least one screw flight, wherein that said screw flight system is provided in at least two segments, wherein each segment comprises at least one screw flight section integral to a shaft section, and wherein said at least two segments are arranged for assembling to one another to form said screw flight system.

2. Agitation means as claimed in claim 1, wherein said each shaft section has at least one assembling flange for said assembling to another adjacent shaft section to form said screw flight system.

3. Agitation means as claimed in claim 1, wherein said each segment comprising at least one screw flight section integral to a shaft section is casted, molded and/or forged as one integral segment.

4. Agitation means as claimed in claim 1, wherein said each segments comprises two screw flight sections integral to a shaft section.

5. Agitation means as claimed in claim 1 wherein said at least one screw flight section in one segment forms a helical continuous screw flight with a corresponding at least one screw flight section in an adjacent segment in said screw flight system.

6. Agitation means as claimed in claim 5, wherein each said at least one screw flight section has at east one bolting arrangement edge for assembling to said corresponding at least one screw flight section in an adjacent segment in said screw flight system.

7. Agitation means as claimed, in claim 1, wherein said screw flight system further comprises wear lining elements arranged on and supported by said screw flight sections.

8. Agitation means as claimed in claim 7, wherein said wear lining element are arranged to bridge any screw flight section assembly in said screw flight system.

9. Agitation means as claimed in claim 7, wherein said. wear lining elements are bolted onto said screw flight sections.

10. Agitation means as claimed in claim 8, wherein said wear lining elements are bolted onto said screw flight sections.

11. A vertical grinding mill comprising agitator means as claimed in claim 1.

12. A construction assembly for agitation means as claimed in claim 1, which comprises at least two segments, each segment comprising at least one screw flight section integral to a shaft section, wherein said at least two segments, are arranged to he assembled to one another to form a screw flu gin system.
